(19) United States
(12) Patent Application Publication
(10) Pub. No.: US 2002/0072379 A1
(43) Pub. Date: Jun. 13, 2002

(54) Method and system for locating position for a mobile communication device

(75) Inventors: Ying Chen, Beijing (CN); Fangyan Rao, Beijing (CN)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/992,659

(22) Filed: Nov. 6, 2001

(30) Foreign Application Priority Data
Nov. 10, 2000 (CN) 00133798.X

(51) Int. Cl. H04Q 7/20

(52) U.S. Cl. 455/456; 342/357.14

(57) ABSTRACT

This invention presents methods, apparatus and systems for locating position for a mobile commutation device generally used in applications including mobile commerce. In example embodiments, geo-indicators based on text are inputted by a user with the mobile commutation device. Then, a candidate feature set is generated for each geo-indicator by applying geocoding which maps the text address to a geo-location based on a back end spatial database. The final geo-location information is decided by geoclustering the candidate feature set.

### FIELD OF THE INVENTION

The present invention relates to locating position for a mobile communication device. More particularly, it relates to locating position for a mobile communication device in mobile commerce.

### BACKGROUND OF THE INVENTION

With the advent of mobile commerce, position dependent information service (PDIS) plays a key role in providing position information for mobile PvC devices (such as WAP-enabled phones and PDAs). Position locating for these devices becomes a first step towards supporting PDIS and is an indispensable component in mobile commerce. As is well known for those skilled in the art, a position can be located either in the device side or in the service provider side. An example for the former is a GPS receiver embedded device which can send their geolocation to a server via a (latitude, longitude) pair, and an example for the latter is a GSM operator (machine) which can determine the position of a mobile phone user in a cell scale. But the rare GPS embedded PvC devices and the complexity introduced in the operator prevent these locating mechanism being used popularly.

### SUMMARY OF THE INVENTION

The present invention provides methods, apparatus and systems for locating position for a mobile communication device in mobile commerce. The methods and systems locate a based on the cooperation between a device user and a server. These methods and systems facilitate a user inputting their geo-related text called geo-indicators to a server which can locate the user's position by employing geocoding technology and spatial database extensively.

According to one aspect of the present invention, there is provided an example of a method for locating position for a mobile communication device in mobile commerce, said step comprising inputting geo-indicators (Gi-1, Gi-2, . . . , Gi-n) based on text by a user with the mobile communication device; transmitting the geo-indicators to a back end server; generating a candidate feature set for each geo-indicator by applying geocoding which maps the text address to a geolocation based on a back end spatial database; deciding the final geo-location information by geoclustering the candidate feature set; and transmitting the geo-location information to the mobile communication device.

According to a further aspect of the present invention, there is provided an example of a system for locating position for a mobile communication device in mobile commerce, said system comprising a mobile communication device for inputting geo-indicators (Gi-1, Gi-2, . . . , Gi-n) based on text; geo-location generating means for generating a candidate feature set for each geo-indicator by applying geocoding which maps the text address to geo-location based on a back end spatial database; and clustering means for deciding the final geolocation information by geoclustering the candidate feature set.

### BRIEF DESCRIPTION OF DRAWINGS

The advantages and features of the present invention will become more apparent by the following description of the advantageous embodiment of the present invention, with reference to the drawings, in which:

FIG. 1 is an example of a flow chart illustrating a process of locating position for a mobile communication device according to an example embodiment of the present invention;

FIG. 2 is a schematic view of an example of a system for locating position for a mobile communication device according to the example embodiment of the present invention; and

FIG. 3 is a flow chart illustrating an example of a process of locating position for a mobile communication device according to another advantageous embodiment of the present invention.

### DESCRIPTION OF THE INVENTION

The present invention provides apparatus, methods and systems for locating position for a mobile communication device in mobile commerce. These apparatus, methods and systems locate a position based on the cooperation between a device user and a server. This overcomes the disadvantages of other position locating methods, without a GPS receiver being embedded in the device and without the complexity introduced in the server. These methods and systems facilitate a user inputting their geo-related text called geo-indicators to a server which can locate the user's position by employing geocoding technology and spatial database extensively. According to one aspect of the present invention, there is provided a method for locating position for a mobile communication device in mobile commerce, said step comprising inputting geo-indicators (Gi-1, Gi-2, . . . , Gi-n) based on text by a user with the mobile communication device; transmitting the geo-indicators to a back end server; generating a candidate feature set for each geo-indicator by applying geocoding which maps the text address to a geolocation based on a back end spatial database; deciding the final geo-location information by geoclustering the candidate feature set; and transmitting the geo-location information to the mobile communication device.

The present invention also provides a system for locating position for a mobile communication device in mobile commerce. An example embodiment of a system includes a mobile communication device for inputting geo-indicators (Gi-1, Gi-2, . . . , Gi-n) based on text; geo-location generating means for generating a candidate feature set for each geo-indicator by applying geocoding which maps the text address to geo-location based on a back end spatial database; and clustering means for deciding the final geo-location information by geoclustering the candidate feature set. The methods and systems according to the present invention have no need for additional embedded devices in PvC devices, and have no need for special training for the user of the PvC devices to effectively locate the position.

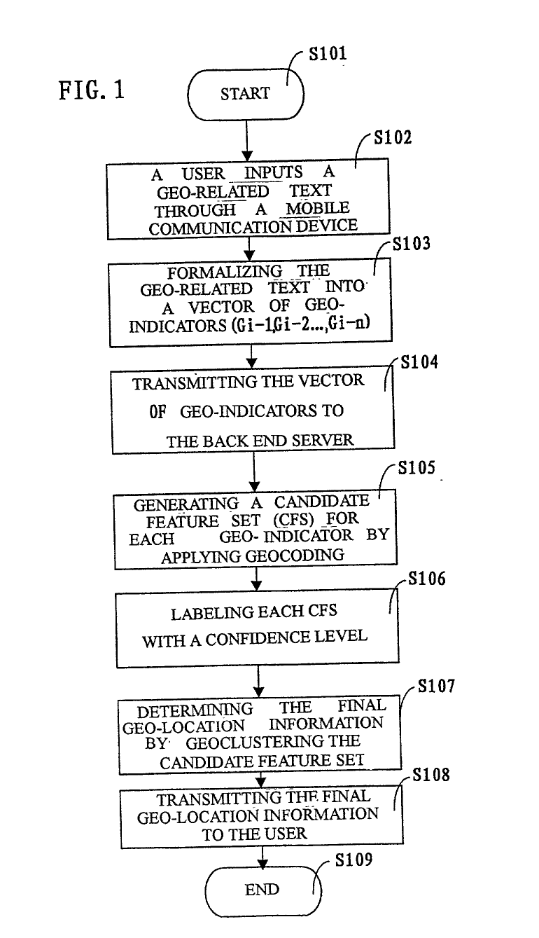

Advantageous embodiments of the present invention are now described in detail with reference to the drawings. FIG. 1 shows a process of locating position for a mobile communication device according to an advantageous embodiment of the present invention. As shown in FIG. 1, at step S102, a user inputs a geo-related text through a mobile communication device, such as a WAP-enabled phone and a PDA. The geo-related text could be a street name, a building name, a postal code and a telephone number. At step S103, the geo-related text inputted by the user is formalized into a vector of geo-indicators (Gi-1, Gi-2, . . . , Gi-n), where Gi-j could be a street name, a building name, a postal code and a telephone number. The number of geo-indicators n is preferably 1-3. It should be noted that Gi-j could be an abbreviation of an exact name. Supporting abbreviation is a key feature of LBT of the present invention, which can largely simplify the character-inputting task in a mobile phone, especially in Chinese character context. At step S104, the geo-indicators are transmitted to a back end server. After receiving the geo-indicators, the back end server generates a candidate feature set (CFS) for each geo-indicator by applying geocoding. This step is based on the mapping of a text address to a geo-location based on a back end spatial database. In this step, an important task is to expand a received abbreviation to obtain several potential candidate features (CF). CFS could be a set of points determined by an abbreviated building name, a set of lines determined by an abbreviated road name, or a polygon determined by a postal code or a prefix of a telephone number which always show regional characteristics. At step S106, each CFS is labeled with a confidence level which is the quantity computed from corresponding CF data set in the spatial database. At last, at step S107, the final geo-location information is determined by geoclustering the candidate feature set. The geometry relationship (such as distance, contain, intersect, etc.) and the confidence level are taken into account when geoclustering the candidate feature set. The geoclustering algorithm exploits the spatial database spatial functions and selects a result feature in the winning cluster.

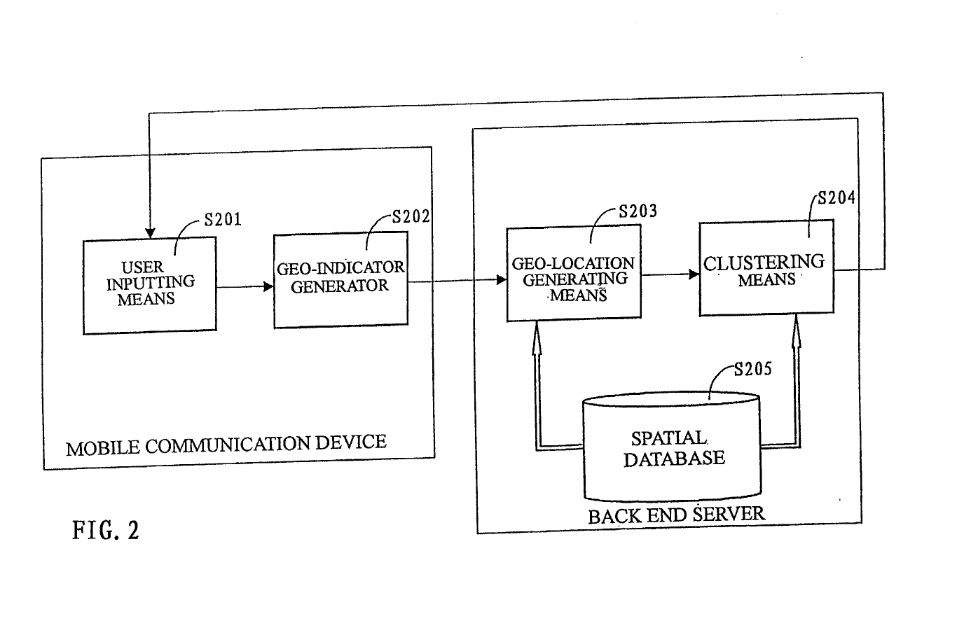

As above, the process of locating position for a mobile communication device according to an advantageous embodiment of the present invention has been described with reference to FIG. 1. A system for locating position for a mobile communication device will now be described with reference to FIG. 2. As shown in FIG. 2, the system is formed of two parts: a plurality of mobile communication devices and a back end server. In one of the plurality of mobile communication devices (such as a WAP-enabled phone and a PDA), the user inputs a geo-related text. The geo-related text inputted by the user is formalized into a vector of geo-indicators (Gi-1, Gi-2, . . . , Gi-n) by a geoindicator generator 202. The generated geo-indicators (Gi-1, Gi-2, . . . , Gi-n) are transmitted to a back end server via a wireless channel. In the back end server, geo-location generating means 203 generates a candidate feature set (CFS) for each geo-indicator by applying geocoding. The geo-location generating means maps the text address to a geo-location based on the back end spatial database. Each CFS is labeled with a confidence level according to the corresponding CF data set in the spatial database. Clustering means 204 geoclusters the candidate feature set. CFS could be a set of points determined by an abbreviated building name, a set of lines determined by an abbreviated road name, or a polygon determined by a postal code or a prefix of a telephone number which always show regional characteristics. The clustering means 204 takes into account the geometry relationship (such as distance, contain, intersect, etc.) and confidence level when geoclustering the candidate feature set. The final geo-.location information is determined by the back end server, and is transmitted to the user of the mobile device via a wireless channel.

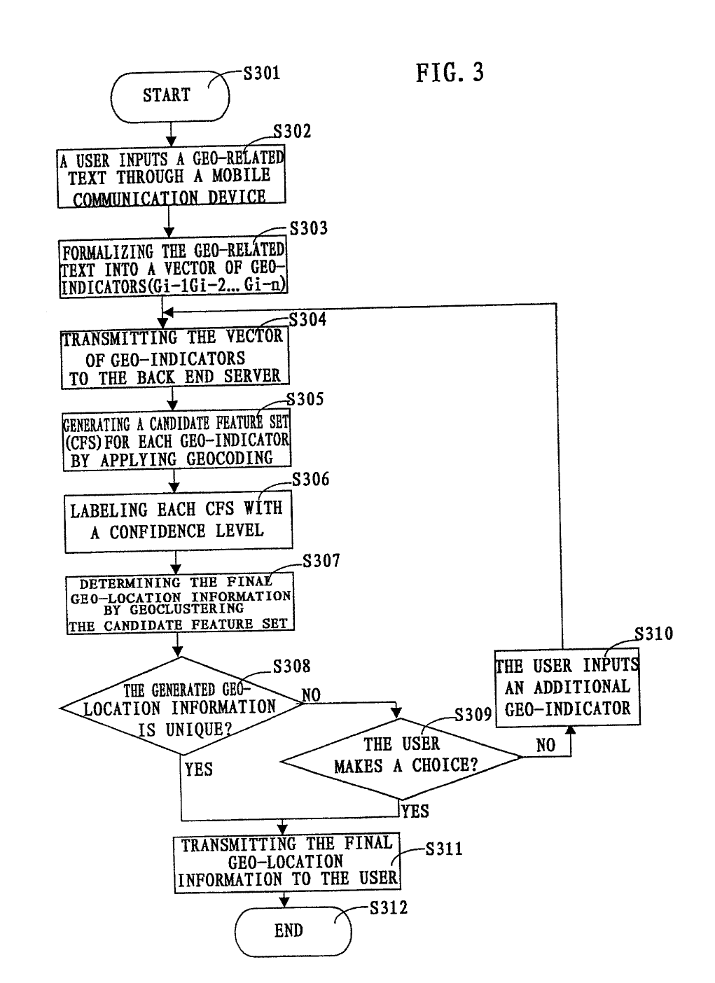

FIG. 3 is a flow chart illustrating a process of locating position for a mobile communication device according to another advantageous embodiment of the present invention. A user may input one geo-indicator which implies multiple locations. It's a usual case in Chinese abbreviations. In such a case the user's choice may be fedback, the geomarching engine then can refine its geoindicator dictionary. For instance, it can add new indicators, index the geoindicator dictionary with the frequency of being used in history, or even provide a tailored dictionary for each user respectively. The feedback mechanism makes geomarching engine more intelligent and adaptable to locate users more precisely. As shown in FIG. 3, if the system determines the generated geo-location information is not unique at step S308, then the user either makes a choice or inputs an additional geo-indicator.

The method and system for locating positions for a mobile communication device in mobile commerce according to the present invention have well addressed the position-locating issue in a mobile device context especially for mobile phone based on geocoding and spatial database technologies. The method and system for locating positions for a mobile communication device according to the present invention have many advantages. First, it is obviously showed that two geo-indicators combination, only need several key strokes in mobile phone, could locate an exact position with a high probabity. However, achieving the same result in a mobile phone with Chinese character input support means time consuming task of inputting PinYin which requires lots of strokes. Secondly, new type of geo-indicator can be plug into system for a specific application context. For example, a type sticked geo-indicator which not only includes the name of the feature but also the type, e.g., hotel, shop, hospital. These kinds of geo-indicators will definitely improve the confidence level of the CFS derived from it. Thirdly, the result feature position is precise enough in mobile commerce environment, e.g., location-dependent advertising, traffic information and answers to kinds of “how can I go to . . . ?” questions. At last, LBT over PvC devices requires no cost at the client side and almost no learning curve. From the cost perspective, it can be adapted to all kinds of devices equipped with a dial pad. In conclusion, LBT is a practical approach to position locating in a mobile commerce context where position of the user is basic data for providing PDIS. Various changes and modifications may be made without departing from the scope and spirit of the present invention. It should be understood that the present invention is not limited to the specific embodiments, and the scope of the present invention is defined by the appended claims.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A method for locating position for a mobile commutation device, comprising:
inputting geo-indicators (Gi-i, Gi-2, . . . , Gi-n) based on text by a user with the mobile commutation device;
transmitting the geo-indicators to a back end server;
generating a candidate feature set for each geo-indicator by applying geocoding which maps the text address to a geo-location based on a back end spatial database;
deciding the final geo-location information by geoclustering the candidate feature set; and
transmitting the geo-location information to the mobile communication device.

2. A method for locating position for a mobile communication device according to claim 1, wherein the geo-indicators (Gi-1, Gi-2, . . . , Gi-n) are based on text inputted by the user with the mobile commutation device, Gi-j is an item selected from a group of items including: a street name, a building name, a postal code, a telephone number, and any combination of these.

3. A method for locating position for a mobile communication device according to claim 1, wherein the geo-indicators (Gi-1, Gi-2, . . . , Gi-n) are based on text inputted by the users with the mobile commutation device, Gi-j is selected from a group including an abbreviation of a street name and/or a building name, a local code of a postal code, a telephone number, and any combination of these.

4. A method for locating position for a mobile communication device according to claim 1, wherein said candidate feature set is a set of points determined from an item in a group of items including: a building name, a set of lines determined by a road name, a polygon determined by a postal code, a telephone number, and any combination of these.

5. A method for locating position for a mobile communication device according to claim 1, wherein said candidate feature set is labeled with a confidence level.

6. A method for locating position for a mobile communication device according to claim 5, wherein the geometry relationship and confidence level is taken into account when geoclustering said candidate feature set.

7. A method for locating position for a mobile communication device according to claim 1, further comprising a step of feeding back a choice made by the user and/or adding an additional geo-indicator inputted by the user, in order to locate said position precisely.

8. A system for locating position for a mobile commutation device, comprising: a mobile communication device, for inputting geo-indicators (Gi-1, Gi-2, . . . , Gi-n) based on text;
geo-location generating means, for generating a candidate feature set for each geo-indicator by applying geocoding which maps the text address to an geo-location based on a back end spatial database; and
clustering means, for deciding the final geo-location information by geoclustering the candidate feature set.

9. A system for locating position for a mobile communication device according to claim 8, wherein said mobile communication device is a WAP phone or a PDA.

10. A system for locating position for a mobile communication device according to claim 8, wherein the geo-indicators (Gi-1, Gi-2, . . . , Gi-n) based on text inputted by the user with the mobile commutation device, Gi-j is selected from the group of items including: a street name, a building name, a postal code, a telephone number, and any combination of these.

11. A system for locating position for a mobile communication device according to claim 10, wherein the geo-indicators (Gi-1, Gi-2, . . . , Gi-n) based on text inputted by the user with the mobile commutation device, Gi-j could be an abbreviation of a street name and a building name, or the local code of a postal code and a telephone number.

12. A system for locating position for a mobile communication device according to claim 8, wherein said candidate feature set could be a set of points determined by a building name, a set of lines determined by a road name, or a polygon determined by a postal code or a telephone number.

13. A system for locating position for a mobile communication device according to claim 8, wherein said candidate feature set is labeled with a confidence level.

14. A system for locating position for a mobile communication device according to claim 13, wherein the geometry relationship and confidence level is taken into account when geoclustering said candidate feature set.

15. A system for locating position for a mobile communication device according to claim 8, further comprising result feedback means wherein a choice is made by the user or an additional geo-indicator is inputted by the user in order to locate the position precisely.

16. An article of manufacture comprising a computer usable medium having computer readable program code means embodied therein for locating a position for a mobile commutation device, the computer readable program code means in said article of manufacture comprising computer readable program code means for causing a computer to effect the steps of claim 1.

17. A program storage device readable by machine, tangibly embodying a program of instructions executable by the machine to perform method steps for locating a position for a mobile commutation device, said method steps comprising the steps of claim 1.

18. A computer program product comprising a computer usable medium having computer readable program code means embodied therein for causing a system for locating position for a mobile commutation device, the computer readable program code means in said computer program product comprising computer readable program code means for causing a computer to effect the functions of claim 8.
